(19) United States
(12) Patent Application Publication
(10) Pub. No.: US 2009/0044270 A1
(43) Pub. Date: Feb. 12, 2009

(54) NETWORK ELEMENT AND AN INFRASTRUCTURE FOR A NETWORK RISK MANAGEMENT SYSTEM

(76) Inventors: Asaf Shelly, Holon (IL); Moshe Feldman, Eilat (IL)

Correspondence Address: Naomi Assia Law Offices;C/O Landon IP Inc., Suite 450, 1700 Diagonal Road, Alexandria, VA, 22314, US

(21) Appl. No.: 11/834,697

(22) Filed: Aug. 7, 2007

(51) Int. Cl. G06F 15/18

(52) U.S. Cl. 726/22

(57) ABSTRACT

A system for a communication infrastructure in a network including at least one connected system (CS) and at least one network risk management network element (SW), wherein the network acts as a virtual network comprising at least one virtual network element, and wherein the at least one virtual network element takes over the roles of existing network elements comprising at least one of a switch, a router, a firewall and an intrusion prevention system (IPS), and wherein the virtual network is comprised of physical elements that work together to form the network's infrastructure.

### RELATED APPLICATIONS

Cross-reference is made to co-pending provisional patent application number Ser. No. 10/______, titled “Software for a Realtime Infrastructure,” filed Jul. 10, 2007, for which the present application is a continuation-in-part and which is incorporated herein by reference and. Cross-reference is also made to co-pending provisional patent application number Ser. No. 10/______, titled “Advanced Processor Technology,” also filed Jul. 10, 2007, which again is incorporated herein by reference.

### FIELD OF THE INVENTION

The present invention relates generally to network risk management, and more particularly, the invention relates to a network element and an infrastructure for a network risk management system.

### BACKGROUND OF THE INVENTION

The common network open system interconnection (OSI) model has the following 7 layers:

Layer 1. Physical layer

Layer 2. Data Link layer

Layer 3. Network layer

Layer 4. Transport layer

Layer 5. Session layer

Layer 6. Presentation layer

Layer 7. Application layer

Currently networks commonly have the following elements:

For connection between network elements (clients and network segments):
A Hub operates on layer 1 of the OSI model;
A Switch operates on layer 2 of the OSI model (may have level 3 functions); and
A Router operates on layer 3 of the OSI model.

Network security elements:
Firewall: Traffic control and basic network management. Mainly separation of network segments (ex. internal, external, DMZ, etc.);
Application Firewall: Inspection of traffic on the application level. Such firewall knows the application and its behavior;
Intrusion Prevention System (IPS): Filters the network for detection of malicious communications. Between different forms we find a filter device between network elements, a device that connects to network elements (switch, router, etc.), and a device that connects to other network security elements. Connecting to network elements means asking these elements to send the traffic passing through them or parts of it; and
Client Control Servers: used for login, to install network policies on client computers, and verify that client computers are updated and secured.

Client security elements:
Personal Firewall: is a firewall located on the client computer to protect it from any unverified external communication;
Anti Virus: is expected to secure the system by detecting known types of harmful software and removing them; and
Anti Spyware: is expected to find applications that may damage user experience or send information stolen from the computer to external network clients or elements.

FIG. 1 is a schematic block diagram of a prior art network. Information from the Internet 110 passes into the organization via a firewall 130. From Firewall 130 information enters the IPS 120 and through the DMZ switch 140, information enters the server 150. After passing one or more switches 160, the information enters the organization personal computers (PC's) 170.

The current network topology is bound to the physical elements and every switch connected to other network elements must have physical ports to allow physical wires to connect to it. In such a configuration Firewall 130 has to be physically connected to Internet 110 before DMZ switch 140 and before the internal network's switches 160.

Management of such networks is extremely difficult and lacking. It is very hard for the network administrator to supervise internal traffic, since the main control point is Firewall 130.

FIG. 2 is a prior art schematic block diagram of a partial solution. Once information from the Internet 210 passes the Firewall 230 into the IPS servers 220 and into the internal network 250 and DMZ servers 240, one relies on the connected computers to handle themselves. For example, if the security policy does not allow an application file or ZIP file to be let in via email, a client may use an FTP server to download the same file, or send it using Instant Communication, such as Messenger, ICQ, etc. Once the file is inside the network, it is hoped that the client has an Anti Virus application that can scan the file to verify that it is absolutely secure.

Any communication between two clients directly will not go via Firewall 230, thus making such communication completely unsafe. It is possible that a single internal network 250 will have a few thousands clients connected without a Firewall between them. Statistically this poses a bigger threat than the immediate threat from Internet 210 itself.

Thus it would be desirable to provide communication between two or more clients directly via the Firewall, thus making such communication completely safe and to provide a network topology that is less bound to physical limitations.

### SUMMARY OF THE INVENTION

Accordingly, it is a principal object of the present invention to provide communication between two or more clients directly via the Firewall, thus making such communication completely safe.

It is another principal object of the present invention to provide better network management and better security.

It is one other principal object of the present invention to provide a network topology that is less bound to physical limitations.

A network risk management network element (SW) replaces a network Switch or a network Router and has at least one input/output (I/O) pin. The system includes at least one targeted machine in at least one connected system (CS), which is any system that an SW can connect to or communicate with, such as a server, computer, SW, FW, Intrusion Prevention System (IPS), IDS or any network element or network system.

A system is disclosed for a communication infrastructure in a network including at least one connected system (CS) and at least one network risk management network element (SW), wherein the network acts as a virtual network comprising at least one virtual network element, and wherein the at least one virtual network element takes over the roles of existing network elements comprising at least one of a switch, a router, a firewall and an intrusion prevention system (IPS), and wherein the virtual network is comprised of physical elements that work together to form the network's infrastructure.

The present invention provides a network topology based on a virtual network element that takes over the roles of existing network elements such as switch, router, and possibly firewall, intrusion prevention systems (IPS), etc. The virtual network is comprised of physical elements that work together to form the network's infrastructure. The network topology can be configured using an external management element.

Each network element (SW) is called a Gal. The entire system is called a Yam, which comprises Gal network elements.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, a preferred embodiment will now be described, by way of a non-limiting example only, with reference to the accompanying drawings, in which:

FIG. 1 is a prior art schematic block diagram of a physical network that the client sees;

FIG. 2 is a prior art schematic block diagram;

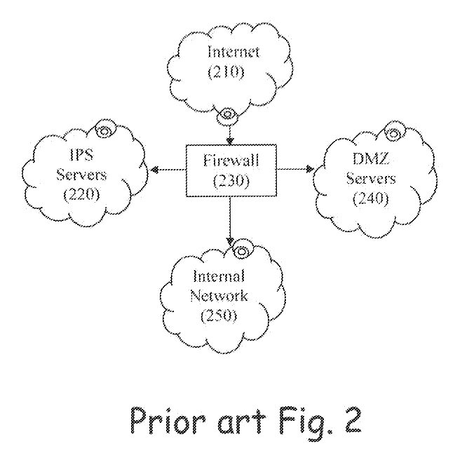

FIG. 3 is a schematic block diagram of an exemplary logical embodiment of a virtual network, or the topology that the client sees, even though it is not physically so, constructed in accordance with the principles of the present invention;

FIG. 4 is a schematic block diagram of an exemplary physical network that supports these virtual topologies, constructed in accordance with the principles of the present invention;

FIG. 5 is a schematic block diagram of an alternative exemplary logical embodiment of a virtual network, constructed in accordance with the principles of the present invention;

FIG. 6 is a schematic block diagram of another alternative exemplary logical embodiment of a more complex virtual network, constructed in accordance with the principles of the present invention;

FIG. 7a is a schematic block diagram of a hypothetical network architecture that is neither reasonable nor secure to use in a prior art network; and

FIG. 7b is a schematic block diagram of a preferred embodiment of the Gal-Yam network architecture, which allows physical connection of any topology, while still maintaining logical separation between network elements, constructed in accordance with the principles of the present invention;

FIG. 8 is a schematic block diagram of an exemplary logical network topology of the Gal-Yam network architecture, which is allowed by the exemplary physical connections of FIG. 7b, constructed in accordance with the principles of the present invention;

FIG. 9 is a schematic block diagram of an exemplary physical network topology of the Gal-Yam network architecture, constructed in accordance with the principles of the present invention, wherein all internal traffic of the virtual Yam system is virtually tunneled;

FIG. 10 is a schematic block diagram illustrating application of the logical network configuration so that connected systems ‘see’ isolated tunnels connecting two systems using a virtual direct cable, constructed in accordance with the principles of the present invention;

FIG. 11 is a schematic block diagram illustrating application of the physical network configuration allowing physical connection of connected systems with different trust levels, constructed in accordance with the principles of the present invention;

FIG. 12 is a schematic illustration of the Clearance Levels for the Gal-Yam system using a model called the Clearance Ring model, constructed in accordance with the principles of the present invention;

FIG. 13 is a schematic block diagram illustrating movement between Clearance Levels, constructed according to the principles of the present invention;

FIG. 14a is a schematic block diagram of an exemplary physical network that supports the virtual topologies of the present invention;

FIG. 14b is a schematic block diagram illustrating the virtual processing Gal-Yam system seen during operation of the physical network of FIG. 14a, constructed according to the principles of the present invention;

FIG. 15 is a schematic block diagram illustrating the virtual processing Gal-Yam system of FIG. 14b in terms of central processing units, co-processing units and peripherals, constructed according to the principles of the present invention; and

FIG. 16 is a schematic block diagram of a prior art implementation of the system of FIG. 15 for an exemplary single computer machine having all CPU cores inside a single chip, such as a personal computer (PC) with a Pentium processor.

### DETAILED DESCRIPTION OF AN EXEMPLARY EMBODIMENT

The principles and operation of a method and an apparatus according to the present invention may be better understood with reference to the drawings and the accompanying description, it being understood that these drawings are given for illustrative purposes only and are not meant to be limiting.

The solution provided by the present invention is a Network Risk Management system (NRM). NRM allows better network management, better security and a network topology that is less bound to the physical limitations.

The network topology of the present invention is based on a virtual network element that takes over the roles of existing network elements such as Switch, Router and possibly Firewall, IPS, etc.

The virtual network is comprised of physical elements that work together to form the network's infrastructure. The network topology can be configured using an external management element.

Each network element is called a Gal. The entire system is called a Yam.

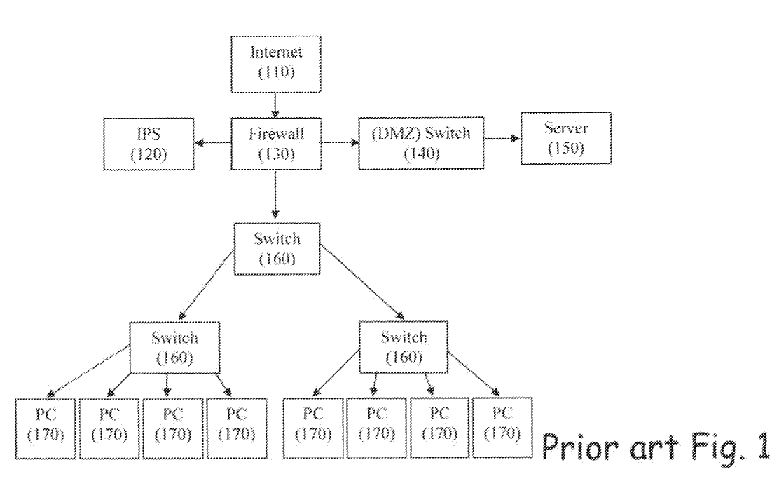

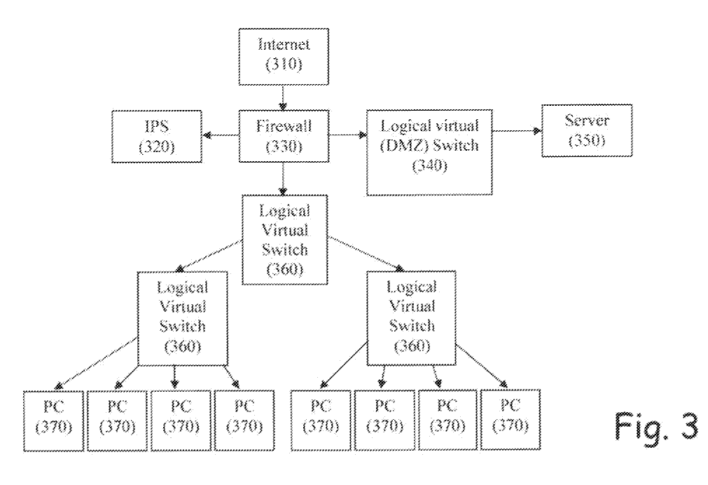

FIG. 3 is a schematic block diagram of an exemplary logical embodiment of a virtual network, constructed in accordance with the principles of the present invention. FIG. 3 appears identical to prior art FIG. 1, because it is the topology that the clients see, even though it is not physically in this form. Any network element or functional unit, including servers, firewalls, IPS, and clients can be remoted using a proxy, and can also be virtual as a software element on the Gal-Yam system.

Information from the Internet 310 passes into the organization via a firewall 330. From Firewall 330 information enters the IPS 320 and through the logical virtual DMZ switch 340, information enters the server 350. After passing one or more logical virtual switches 360, the information enters the organization personal computers (PC's) 370.

The prior art network topology is bound to the physical elements and every switch connected to other network elements must have physical ports to allow physical wires to connect to it. In such a configuration the Firewall has to be physically connected to the Internet before the DMZ switch and before the internal physical network's switches.

The Gal-Yam system of the present invention can have an operating system that runs on all the Gal network elements, using them as work units. These work units behave as Cores in a multicore CPU on one layer. On another layer, each work unit has I/O ports that are part of the large virtual CPU. This virtual CPU runs an operating system on which it is possible to run applications. The virtual CPU can be a multicore CPU.

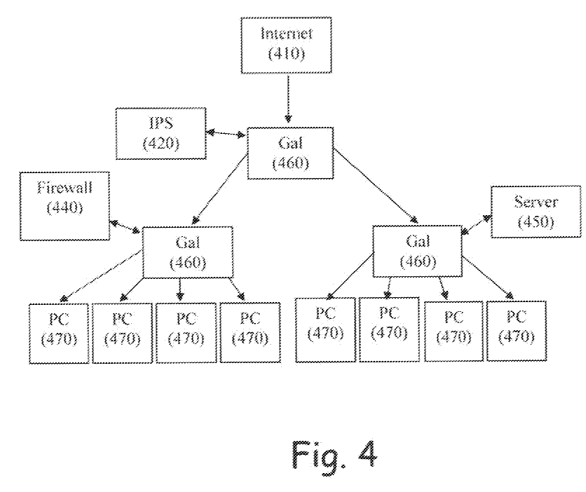

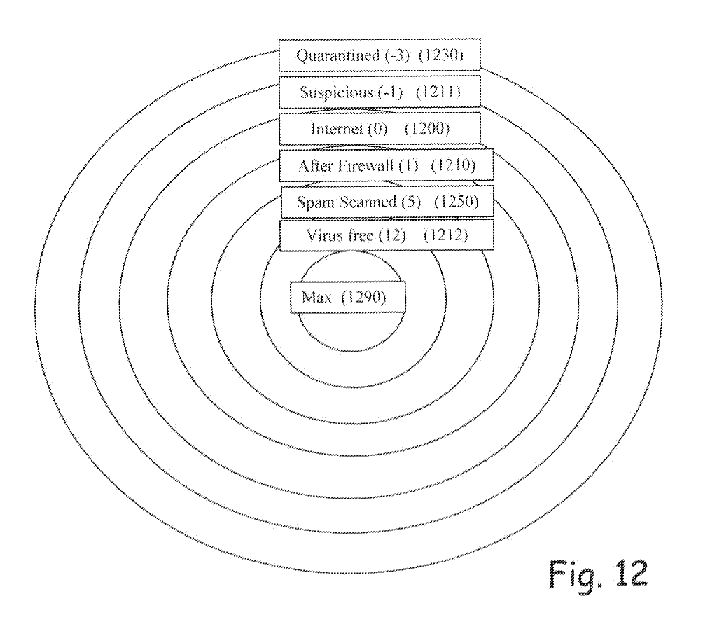

FIG. 4 is a schematic block diagram of an exemplary physical network that supports various virtual topologies, such as that of FIG. 3, constructed in accordance with the principles of the present invention. Information from the Internet 410 appears to pass into all elements of the organization via a Gal network element 460, and from there to other Gal network elements 460, as well as to the Firewall 430, the IPS 420, the server 450 and the organization personal computers (PC's) 470. Information from Internet 410 does not really get to all network elements because of the Clearance Ring Model, as described below with reference to FIG. 12. Thus, information from Internet 410 will not go to secure elements directly. Information from Internet 410 goes to Firewall 430, then to other elements etc., just as the flow in all other Figs.

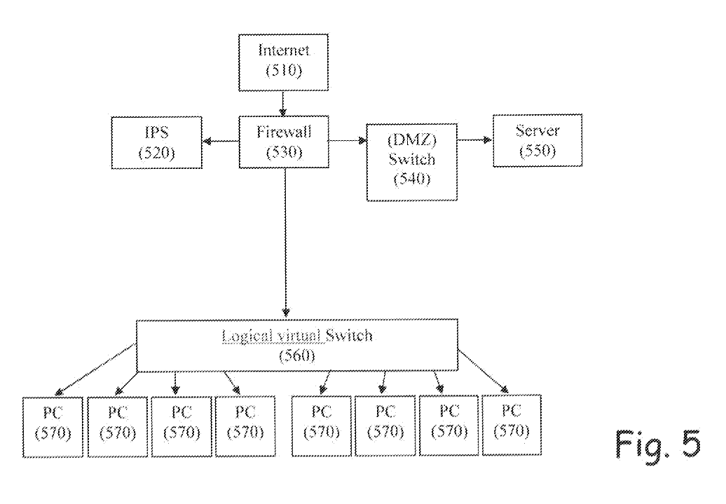

FIG. 5 is a schematic block diagram of an alternative exemplary logical embodiment of a virtual network, constructed in accordance with the principles of the present invention. Information from the Internet 510 passes into the organization via a firewall 530. From Firewall 530 information enters the IPS 520 and through the DMZ switch 540, information enters the server 550. After passing a logical virtual switch 560, the information enters the organization personal computers (PC's) 570.

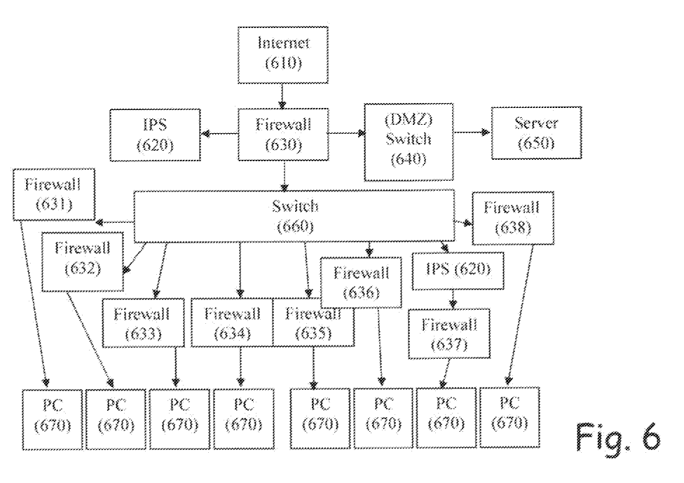

FIG. 6 is a schematic block diagram of another alternative exemplary logical embodiment of a more complex virtual network, constructed in accordance with the principles of the present invention. Information from the Internet 610 passes into the organization via a firewall 630. From Firewall 630 information enters the IPS 620 and through the DMZ switch 640, information enters the server 650. After passing one or more logical virtual switches 660, the information enters the organization personal computers (PC's) 670. Any network element or functional unit, including servers, firewalls, IPS, and clients can be remoted using a proxy, and can also be virtual as a software element on the Gal-Yam system. For FIG. 6 Firewall 630 is remoted to function as logical virtual Firewalls 631-638.

The patent describes a Network Risk Management solution. Such a system can utilize the ability of Network Management to the direction of Network Security. Network security is improved with when there is an improvement in the ability to manage the network, monitor the network, define situations and states, and enforce conditions and rules.

The infrastructure of the Gal-Yam network of the present invention can monitor traffic, log activity, identify attacks between internal network clients and apply any network security methodology and technology that can be used between internal networks and one or more external networks. All this is provided without the need to enforce the security on the servers or clients.

The network risk management can be applied by several means. For example, a central Firewall can manage the entire network by:

connecting to any Gal network element that will deploy to all other units;

connecting to any Gal network element separately; and

connecting to an application running on the virtual CPU, etc.

The Gal-Yam system can simply apply routing rules, but can also produce routing rules by itself, according to different network states and statuses or in response to network threats.

Classic networks isolate connected systems with different trust levels by physical separation. For example, there is a Firewall between the Internet and the internal network, the DMZ is physically separated from the rest of the network and sub-networks are physically detached.

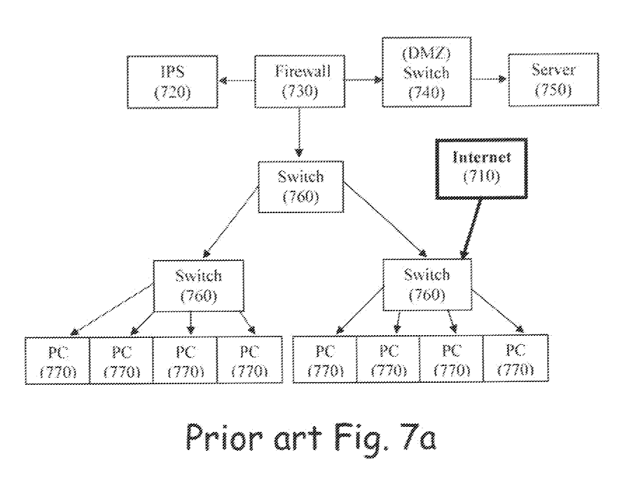

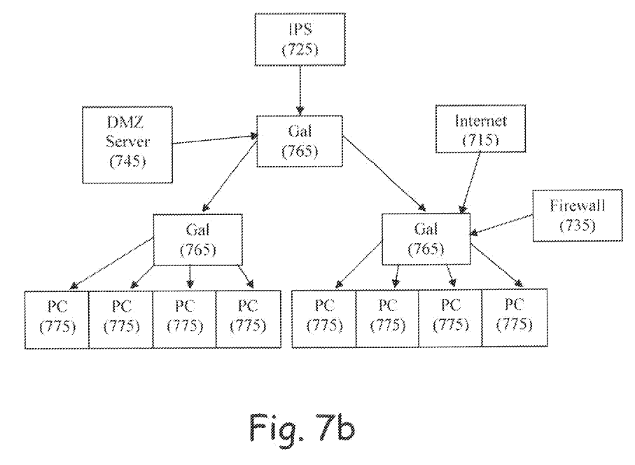

FIG. 7a is a schematic block diagram of a hypothetical prior art network architecture that is neither reasonable nor secure to use in a network. This is because there is no clear separation between systems connected to the same network switch and, for example, any connected system can communicate with another connected system connected to the same switch.

Information from the Internet 710 passes into the organization via a switch 760. From the Firewall 730 information enters the IPS 720 and through the DMZ switch 740, information enters the server 750. Yet, this is irrelevant here, because this is an undesirable configuration, where Internet 710 is directly connected to the protected network without any security. After passing physical switch 760, the information enters the organization personal computers (PC's) 770.

FIG. 7b is a schematic block diagram of a preferred embodiment of the Gal-Yam network architecture, which allows physical connection of any topology while still maintaining logical separation between network elements, constructed in accordance with the principles of the present invention. The physical configuration allows information from the Internet 715 and the Firewall 735 to pass into the organization via a Gal network element 765. From the IPS 725 and the DMZ server 745 information enters another Gal network element 765. After passing one or more Gal network elements 765, the information enters the organization personal computers (PC's) 775.

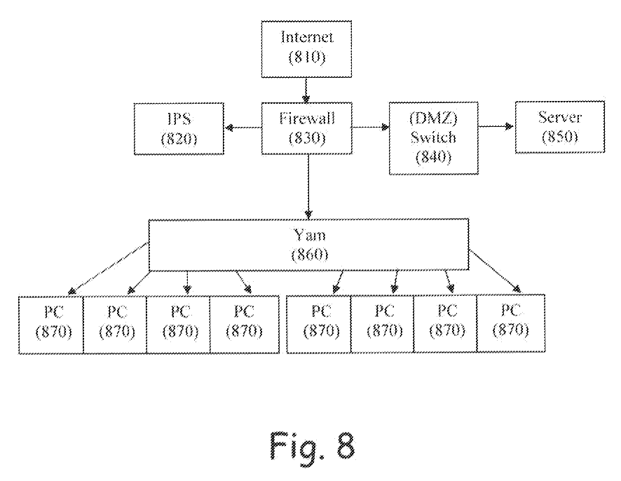

FIG. 8 is a schematic block diagram of an exemplary logical network topology of the Gal-Yam network architecture, which is allowed by the exemplary physical connections of FIG. 7b, constructed in accordance with the principles of the present invention. Information from the Internet 810 passes into the organization via a firewall 830. From Firewall 830 information enters the IPS 820 and through the DMZ switch 840, information enters the server 850. After passing a logical virtual Yam system 860, the information enters the organization personal computers (PC's) 870.

The separation between elements does not have to be physical, thereby providing more flexibility in physical network design.

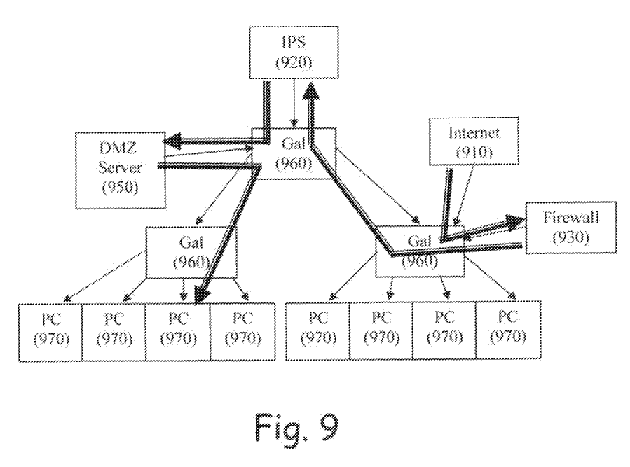

FIG. 9 is a schematic block diagram of an exemplary physical network topology of the Gal-Yam network architecture, constructed in accordance with the principles of the present invention, wherein all internal traffic of the virtual Yam system is virtually tunneled. In addition to the physical connections illustrated by the thin arrows, virtual tunneling connections are shown by thick arrows via Gal network elements 960. These are shown from the Internet 910 to the Firewall 930 and from Firewall 930 to IPS 920, from IPS 920 to the DMZ Server 950, from DMZ Server 950 to a PC 970.

Thus, every system physically connected via a Gal network element can be encrypted on entry and decrypted just before arrival at a destination, so that all internal traffic of the virtual Yam system is encrypted, or virtually tunneled.

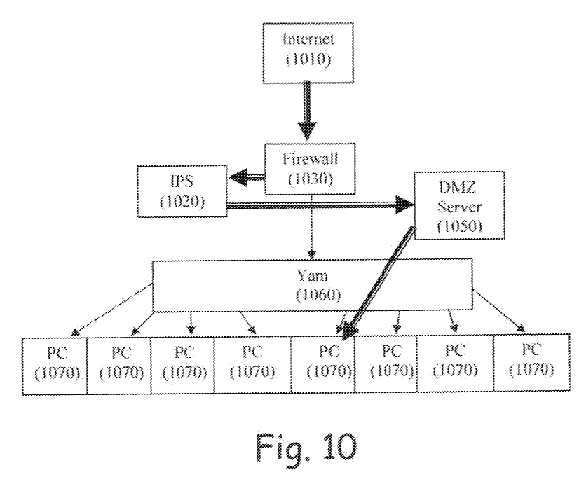

FIG. 10 is a schematic block diagram illustrating application of the logical network configuration so that connected systems ‘see’ isolated tunnels connecting two systems using a virtual direct cable, constructed in accordance with the principles of the present invention. In addition to the physical connections illustrated by the thin arrows, virtual tunneling connections are shown by thick arrows via a virtual direct cable. These are shown from the Internet 1010 to the Firewall 1030, from Firewall 1030 to the IPS 1020, from IPS 1020 to the DMZ Server 1050 and from DMZ Server 1050 to a PC 1070.

This isolation increases security, control over the traffic and improves network management. These direct connections can be predefined by the network administrator or automatically whenever data is moved between the two systems or on connection initiation.

The Gal-Yam system can enforce an internal routing rule for Network Risk Management, such as rerouting all internal traffic through a Firewall or an Anti-Virus. Rules can be selectively applied to specific systems according to Risk Management requirements and decision making. Enforcing Network Risk Management methodologies increases network tolerance to attacks from external systems, but also increases network tolerance to attacks coming from internal network elements and trusted connected systems.

The Gal-Yam system can employ known network security practices, which are commonly used to secure the internal network from attackers that come from an external network, i.e., the Internet, for example, quarantine, honey-pot, data inspection and modification, etc. On the Gal-Yam network there is no physical difference or limitation between external to internal connected systems so the Gal-Yam system can employ network security practices on internal clients and trusted connected systems. This can be achieved without the need for installation on the client or servers in the network (the solution that is used to this day).

The Gal-Yam system can perform basic Network Management functionalities such as monitoring traffic and notifying the administrator on predefined or extreme conditions and statuses. The system can also perform advanced Network Risk Management functionalities such as detection of suspicious connected system, suspicious communication, suspicious user, etc. The system can also take means to secure the system accordingly. This may include reconfiguration or adjustment of routing rules and system topology.

It is possible for the Gal-Yam system to listen to network traffic or interfere with the network traffic, for example for cancellation, modification or delay of communication. The system can also actively produce traffic for several different reasons, such as client identification, detection of harmful software installed on a client, detection of disconnection, etc. This can also include practices such as penetration testing and port scanning, which can be performed by the Gal-Yam system as part of the Network Risk Management methodology.

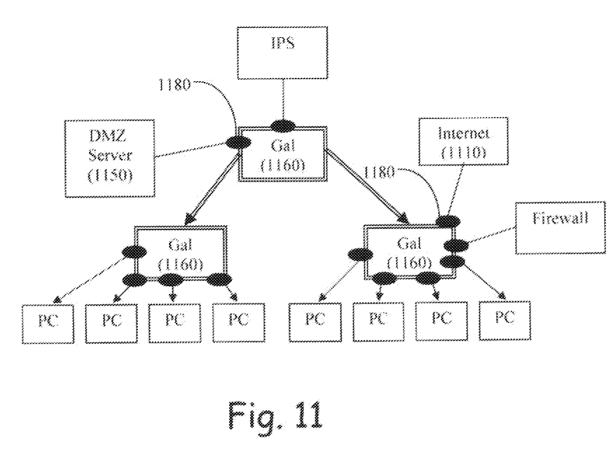

FIG. 11 is a schematic block diagram illustrating the physical connection of connected systems with different trust levels, constructed in accordance with the principles of the present invention. Every network connection, i.e., input/output port 1180, has an identity that also defines its Clearance Level. This does not apply for connections between Gal network elements, since these may operate in any common protocol such as Internet Protocol (IP) or Internet Control Message Protocol (ICMP) to proprietary protocols that are internal to the network. Generally speaking the Gal network elements 1160 should act together to form a single entity. For example, the Internet 1110 and a DMZ server 1150 can be directly physically connected to different Gal units, but logically connected directly, and traffic between them is completely isolated from other connected systems anywhere on the network. This is achieved by definition of trust levels called Clearance Levels for each connected system. Thus, any input to the virtual Yam Network has a definition of its Clearance Level.

FIG. 12 is a schematic illustration of exemplary Clearance Levels for the Gal-Yam system using a model called the Clearance Ring model, constructed in accordance with the principles of the present invention. There could be several parallel Clearance Ring schemas used in a single network. The highest numbers define the most trusted connected system, such as Virus Free (12) 1212, Spam Scanned (5) 1250 and After Firewall (1) 1210. Zero defines an unverified or unknown system, such as the Internet (0) 1200. The lowest numbers (negative in FIG. 12) define the most dangerous connected system, such as Quarantined (−3) 1230 and Suspicious (−1) 1211. There are no rules for Clearance Level enumeration and no limit on high and low values 1290.

The Gal-Yam system may degrade a connected client from any Clearance Level to a lower one for many reasons such as Firewall or IPS recommendation, threat detected, administrator's request, predefined rules, etc.

Any data on the network has a destination. The system compares the target Clearance Level to the source Clearance Level and if they match then the communication may continue. If the Clearance Level of the source is higher than the target, for example, a trusted computer connecting to the Internet, then the communication can continue on the regular route. On the other hand if the Clearance Level of the source is lower then the target's, for example, a source from the Internet is trying to communicate with a trusted machine, then the Clearance Level of the data frame has to be upgraded to at least match the Clearance Level of the target.

This paradigm is more secure than the one used on classic prior art networks because prior art networks have filtering elements between network infrastructure, and on the Gal-Yam network the infrastructure decides whether to pass the data frame or not. In other words the network does not rely on a filtering element to stop the unverified data before it is passed to the destination. Instead the network will pass the data only to targets within the permitted Clearance Level.

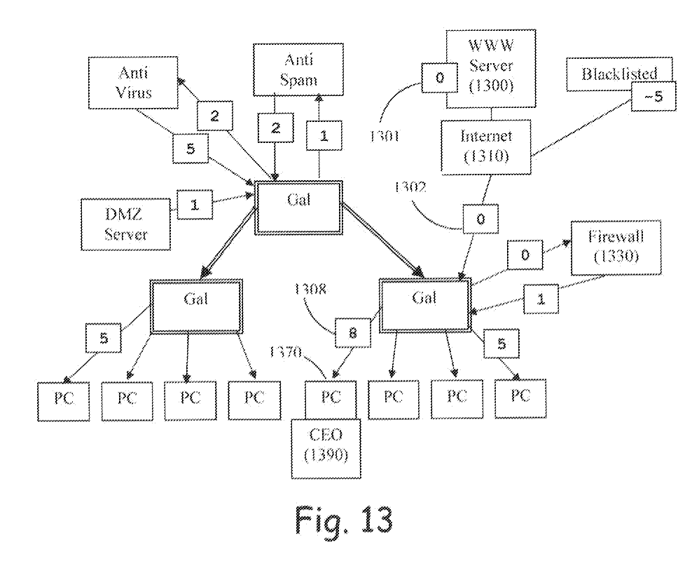

FIG. 13 is a schematic block diagram illustrating movement between Clearance Levels, constructed according to the principles of the present invention. The Gal-Yam system defines a Procedure Set that helps determine how to move between Clearance Levels. When a data frame needs to upgrade its Clearance Level for example from 1 to 12, the system will check the appropriate procedure level that may, for example, involve passing via the Firewall and two IPS systems, delay for 25 minutes, and require Network Administrator's permission.

When the CEO 1390 is browsing to a Web server (“WWW Server”) 1300 on the Internet 1310 the PC 1370 of CEO 1390 will send data to Web server 1300. Since the Clearance Level of the Web site is zero 1301 the data may go to Web server 1300. Server 1300 replies with a data frame that has the Clearance Level of zero 1302, so the source Clearance Level is (0) 1301 and the target Clearance Level is (8) 1308. The system will go over the conversion procedure from (0) to (8) to find that the procedure defines that going from (0) to (8) requires going from (0) to (1), from (1) to (5) and from (5) to (8). Going from (1) to (5) defines going from (1) to (2) and from (2) to (5). The system will then check to see the procedure for going from (0) to (1) and will find that it requires going through the Firewall 1330. After the data is returned form Firewall 1330 it is upgraded to Clearance Level (1). This is an example. The procedure may vary according to system implementation, procedures and rules defined by the network administrator.

Optionally, a Clearance Level Modifier to upgrade or downgrade the Clearance Level of a data frame, machine, application and service on the connected system, etc., according to the mandate given by the Gal-Yam system. It is also possible for a Clearance Level Modifier to block, quarantine or even deny Clearance Level or levels by any other Clearance Level Modifier. For example, the Anti Spam may upgrade the Clearance Level from (1) to (2) but deny the Anti Virus from upgrading the Clearance Level from (2) to (5), or re-enqueue for later inspection within a given period.

Optionally, a simple network appliance or a server running an operating system as a Gal network element may be used. Optionally, several Gal network elements exist on a single network and they communicate with each other.

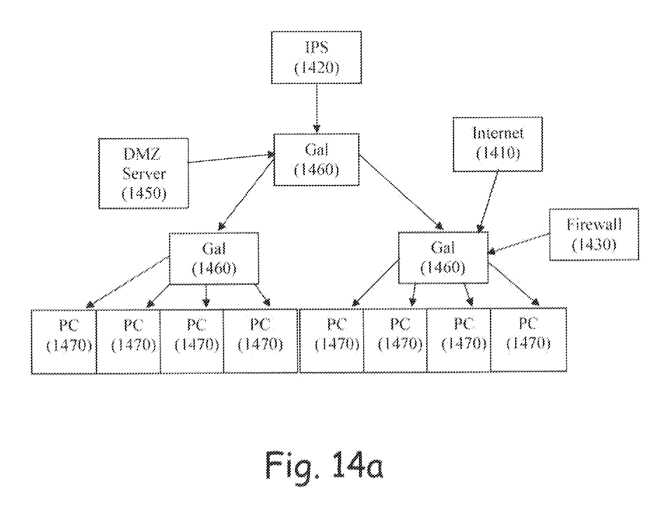

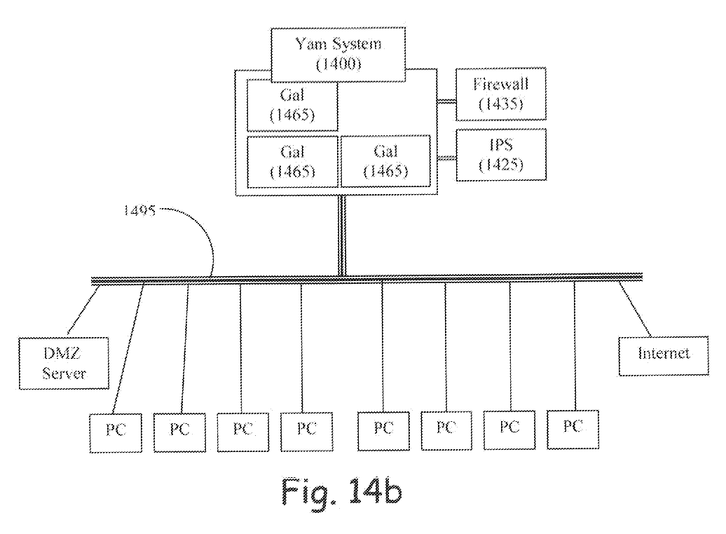

FIG. 14a is a schematic block diagram of an exemplary physical network that supports the virtual topologies of the present invention. Information from the Internet 1410 passes into all elements of the organization via a Gal network element 1460, and from there to other Gal network elements 1460, as well as to the Firewall 1430, the IPS 1420, the DMZ server 1450 and the organization personal computers (PC's) 1470.

FIG. 14b is a schematic block diagram illustrating the virtual processing Gal-Yam system seen during operation of the physical network of FIG. 14a, constructed according to the principles of the present invention. The Gal network elements 1465 of the Yam system 1400 work cooperatively and system 1400 is divided into Work Units. Each work unit can process a task. The tasks in system 1400 are produced by other tasks. A Work Unit can be external, such as an external Firewall 1435 and an IPS 1425 connected to system 1400, or internal like a Gal network element 1465. Gal network elements 1465 have a Task Queue managed by a Network/Streaming Operating System/_Software For A Realtime Infrastructure. The network connection between Gal network elements 1465 is considered as the internal CPU bus 1495 and the network connection from Gal network elements 1465 to other connected systems is considered the external CPU bus/I/O port or ports.

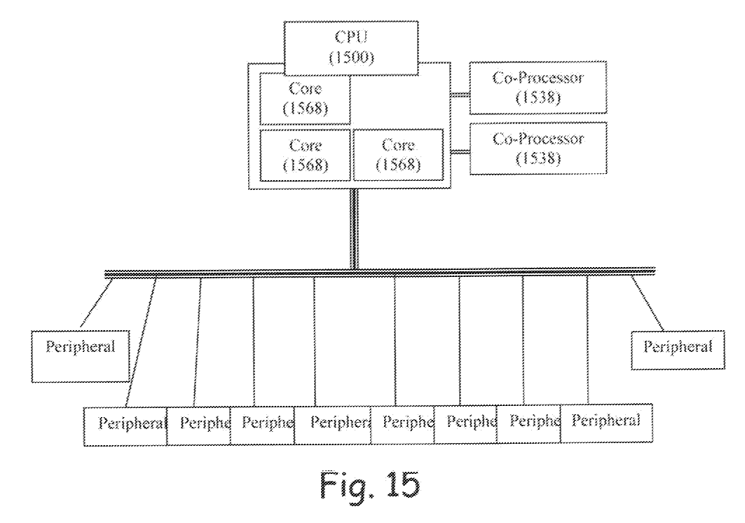

FIG. 15 is a schematic block diagram illustrating the virtual processing Gal-Yam system of FIG. 14b in central processing units, co-processing units and peripherals, constructed according to the principles of the present invention. This is the equivalent of a common implementation of a Central Processing Unit (CPU) 1500 based machine that runs an operating system. The Operating System regards external Work Units as co-processors 1538 and Gal network elements as CPU Cores 1568.

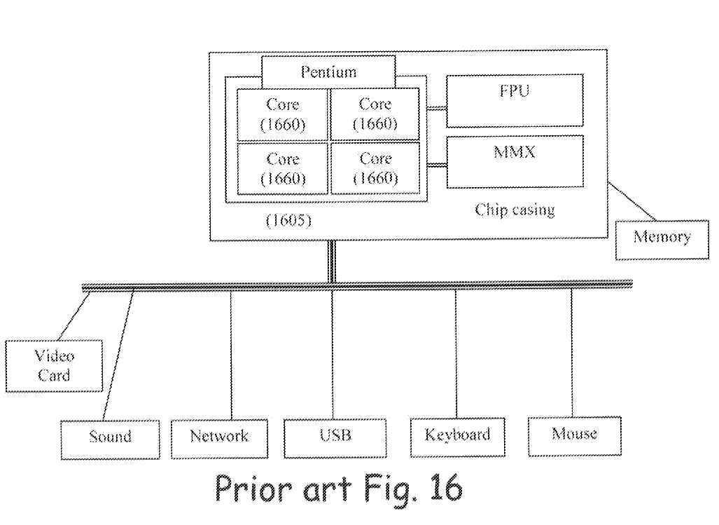

FIG. 16 is a schematic block diagram of a prior art implementation of the system of FIG. 15 for an exemplary single computer machine having all CPU cores inside a single chip, such as a personal computer (PC) with a Pentium processor.

Accordingly, there are several abstraction strata for the Gal-Yam system (this is non-related to the 7 layers of the OSI model for networks):
Physical stratum: Gal network elements are connected to one another using a network connection and all other machines and connected systems are connected to the Gal network elements using a network connection.
Internal CPU stratum: Gal network elements use the communication lines between them to perform as a single entity. This configuration makes each Gal network element a core in the multiprocessor CPU that is the Yam network.
CPU external stratum: The network communication between the Gal network elements and the other units connected to them provides an external I/O bus for the virtual Yam processor. On this stratum every Gal network element is a port extender that has several (network) I/O's, so on this level regardless of the ability of a Gal network element to process information or handle tasks, a Gal network element can also extend the external CPU bus and I/O ports. It is possible that some Gal network elements will only do processing or only be port extenders. On this stratum the external Firewall, IPS, IDS and other security elements perform as co-processors to the virtual Yam CPU.
Virtual Processor Flow Manager: Handles Task scheduling and dispatching between Work units (Gal network elements, external processors, etc.), Task generation and enqueuing, Hardware exception handler, Cache management, Work unit enumeration and profiling and other Kernel Operating System services such as synchronization. Shares responsibility of breaking down tasks into smaller tasks and of exception handling with the Operating System.
Operating System Kernel: Responsible for management of the Virtual Processor, enumeration and profiling of systems connected externally to the Virtual Processor. Shares responsibility of breaking down tasks into smaller tasks and of exception handling with the Virtual Processor. This stratum provides Hardware Abstraction Stratum (HAS) for the Operating System. It is possible to implement the task scheduling, distribution and management on this stratum in cooperation with, in parallel to, or instead of the Virtual Processor Flow Manager.
Operating System Services: Responsible for providing Hardware Abstraction Stratum (HAS) for running applications, synchronization support, Exception handling, and other Operating System services and features that running applications may use.
Application stratum: This stratum comprises applications running on the virtual Yam processor and system. These can be management applications that manage the network and the Gal-Yam system or any other general purpose application. It is also possible to run a Virtual Firewall element as an application that will take the role of the external physical Firewall that is connected as an external co-processor.

Optionally, the Gal-Yam system will offload units such as the Firewall and IPS, or will handle or process tasks generated by such external units. It is also possible in the other way around, that connected units will offload Gal-Yam system generated tasks.

The virtual Yam network processor can support dynamic attachment and detachment of processing cores and co-processors.

The Gal-Yam system can implement Plug and Play paradigms. These may include the following:
1. Communication Timeouts: The system can listen to connected systems and monitor communication so that it is aware of the time of last communication with a connected system. This way the system can know that the connected system is in fact still connected.
2. Keep Alive: periodically the system can initiate communication with a connected system to verify its connectivity. Thus, even if the connected system had no communication with the system, the system can initiate communication with the connected system to verify that it is still connected. If such a connected system does not reply, then the system may indicate that the connected system is no longer connected and take appropriate actions such as indicate on the management console, notify the administrator, respond on behalf of the missing system and cache data sent to it, immediately reply to other systems that the connected system is down, thus reducing timeouts, consider future communication from the given physical connection as being an unknown source, etc.
3. Keep Alive can be performed using any of several methods, including:
   a. Ping: ICMP echo. The connected system will reply if it is connected.
   b. ARP and MAC based: lower stratum communications on layer 3 of the OSI model can be used to verify connected system's connectivity.
   c. Signaling: The system can be physically connected to the connected units so layer 2 of the OSI model can be used to verify connected system's connectivity.
   d. Physical: The system may also use indication of physical connection such as a physical electronic sensor that can sense cable attachment and detachment, or by using electrical sensors that can sense electrical conductivity, activity, and/or wire capacitance.
   e. Applicative Level: It is possible for the system to monitor and communicate with a connected unit using a higher level protocol that such as HTTP, FTP, SOAP, RPC, etc., or mid level protocol such as opening a TCP socket specifically for the response.
4. The system can use higher layers of the OSI model to communicate with a connected system. This can help the system detect connected systems and installed services on connected systems. Optional mapping strata include:
   a. Physical Link: map all wires connected to ports of the Gal network elements.
   b. Physical Device: map devices connected to ports on the Gal network elements.
   c. Connected Systems: map connected systems connected to the Gal-Yam system.
   d. Functional Systems: map functional units such as Firewall, IPS, servers, etc. These can be hardware devices, but can also be software applications on the system.
   e. Services: map installed services on a connected system.
   f. Users: map users connected to/through the Gal-Yam system network.
   g. Forces: map attackers and friendly systems both inside the network and external to the Gal-Yam network system.
   h. Vulnerability: map insecure systems by possible activities, infections, outdated software, data sensitivity, etc.
5. For mapping purposes the system can use any of the following methodologies:
   a. Monitor and listen to network traffic in/out of a connected system.
   b. Actively initiate communication to a connected system.
   c. Interfere with traffic in a way that can invoke behavior or non-behavior.
   d. Non-penetration scans can initiate communication on different levels of protocol, such as run over ports, run over web site files, attempt communication with an assumed host (assuming the host is there, this can also detect back doors and worms), etc.
   e. Penetration scans may actively attack a connected system, host, user, service, application, etc. The goal of such an attack is to detect the behavior of the target in order to identify the target, as well as make sure that the target is in fact secure as its current mapping indicates.
   f. Any known hacker/cracker/system exploit/system detection mechanism used to attack internal systems from the outside can be used by the network itself in the process of mapping the network.
6. Mapping the network and remapping the network can happen for many reasons such as:
   a. Indication of connected system connect/disconnect.
   b. Periodic scheduled mapping.
   c. Dead connected system/service/application detected.
   d. Connected System/service/application misbehavior.
   e. Connected System/service/application break expected protocol or communication.
   f. Administrator's request.
   g. System initialization.
   h. System setup.
   i. Connected System inactivity for a timeout.
7. Mapping methodologies can help detect the network mapping as well as mapping faults, such as a misplaced unit, wrong unit, error in manual mapping, etc.
8. Using these methodologies and others the Gal-Yam system network can be a Plug and Play network, detecting connection and disconnection of units and detecting a connected system's profile and characteristics.
9. The network itself can enforce a connected system to update its software/firmware to accommodate network security restrictions. This is performed by the network, and no action is required by an application server connected to the network.”. Thus, the network's infrastructure for the present invention does what is done in the prior art using a server. In the prior art the computer logs in to the server and the server enforces special rules if the PC wants to login. The present invention does not need a server for it, because the network itself verifies computer security and compatibility. This function can also be performed by the domain server to which all clients log in.
10. The system may use encryption between end points, or internally between Gal network elements in the Yam network complex.
11. To increase encryption strength the system may compress data before encryption and decompress after decryption. This increases data security and reduces exposure of encryption keys because compression (such as ZIP) reduces repeating elements and produces a unique identifier to the compressed data, so the encryption operates on three unique elements instead of two primary numbers (that are unique) and a non-primary number as the data (that is a multiple of many weak primary numbers).

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

SW refers to a network element, which replaces a network Switch or a network Router And has at least one input/output (I/O) pin.

FW is Firewall.

CS—a connected system, which is any system that an SW can connect to or communicate with, such as a server, computer, SW, FW, Intrusion Prevention System (IPS), IDS or any network element or network system.

APP—a software application or service installed on a CS.

NF—Network Function—APP or CS or CS on which an APP is installed, providing services to network clients, whether an appliance or virtual, such as FW, Web server, mail server, anti-virus scanner, etc.

We claim:

1. A system for a communication infrastructure in a network, said system comprising:
at least one connected system (CS); and
at least one network risk management network element (SW),
wherein said network acts as a virtual network comprising at least one virtual network element, and wherein said at least one virtual network element takes over the roles of existing network elements comprising at least one of a switch, a router, a firewall and an intrusion prevention system (IPS), and wherein said virtual network is comprised of physical elements that work together to form the network's infrastructure.

2. The SW system of claim 1, wherein the communication infrastructure is an active SW that monitors traffic.

3. The SW system of claim 1, wherein the communication infrastructure is said at least one SW that records traffic logs.

4. The SW system of claim 1, wherein the communication infrastructure is at least one SW that can isolate each of said at least one CS from every other at least one CS.

5. The SW system of claim 1, wherein the communication infrastructure is at least one SW that enforces security rules to prevent attacks between different at least one CS's.

6. The SW system of claim 1, wherein said network is protected by a firewall (FW) that controls and manages the SW system in said protected network.

7. The SW system of claim 6, wherein said FW and the SW system comprise a single management system for rule enforcement and log handling.

8. The SW system of claim 1, further comprising at least one management interface (MI) in communication with a network administrator, that allows a configurable network topology.

9. The SW system of claim 8, wherein said FW can deploy feature updates and security updates to said at least one SW in the internal network, wherein said at least one MI is a dedicated appliance comprising at least one of a computer, PDA and a cellular phone.

10. The SW system of claim 7, wherein said at least one SW is configured with at least one designated I/O pin to act as one of at least: an input; an output; a filtered input (FW protected); and a DMZ.

11. The SW system of claim 6, further comprising at least one of an intrusion protection system (IPS) and an intrusion detection system (IDS).

12. The SW system of claim 11, wherein the SW system offloads tasks at least from said FW and said IPS.

13. The SW system of claim 11, wherein the SW system offloads tasks at least to said FW and said IPS.

14. The SW system of claim 1, wherein the SW system is also anti virus scanner.

15. The SW system of claim 1, wherein the SW system can apply FW capabilities to each of said at least one CS.

16. The SW system of claim 15, wherein said FW capabilities comprise at least: quarantine; honey pot; and data modification.

17. The SW system of claim 8, wherein the SW system reports to said MI regarding suspicious behavior by one of said at least one CS.

18. The SW system of claim 6, further comprising said FW and the SW system having a single management and information system.

19. The SW system of claim 18, wherein all of said at least one SW's are managed by said FW and said FW has said single management and information system.

20. The SW system of claim 1, wherein the SW system makes routing decisions based on information collected about said at least one CS.

21. The SW system of claim 20, wherein the SW system denies routing for some of the available networks after detection of suspicious behavior.

22. The SW system of claim 21, wherein said suspicious behavior is port scanning.

23. The SW system of claim 6, wherein the SW system is a protected system, and wherein said at least one SW takes the role of said FW.

24. The SW system of claim 1, further comprising Security Rings using virtual networks on the SW system.

25. The SW system of claim 1, further comprising Internal network tunneling so that every at least one CS is encrypted on the first at least one SW and decrypted on the last at least one SW, thereby preventing at least one of sniffing of the network for this data and modification of network data.

26. The SW system of claim 25, wherein said tunneling is between each of said at least one CS in the network so that a large set of said at least one CS's share the same network address space and are virtually connected directly to each other.

27. The SW system of claim 1, further comprising a clearance rings model, wherein clearance is according to a model of concentric zones.

28. The SW system of claim 27, wherein each of said at least one I/O pins of said at least one SW has a defined clearance level.

29. The SW system of claim 27, wherein one of an unverified source and an unknown source is clearance level 0.

30. The SW system of claim 29, wherein if the target clearance is higher than the current clearance level, then the SW system checks for the procedure to increase said current clearance level to said target level incrementally.

31. The SW system of claim 29, wherein said current clearance level can be one of incremented, decremented, and vetoed.

32. The SW system of claim 1, further comprising cooperative network management between said at least one of SW's.

33. The SW system of claim 1, wherein at least one SW is a work unit.

34. The SW system of claim 1, wherein said network is a virtual network over the physical network.

35. The SW system of claim 34, wherein said network is at least one virtual local LAN.

36. The SW system of claim 8, wherein said MI instructs said network administrator how to react to a situation, said instruction comprising at least a checklist that said network administrator preferably is to follow based on predefined rules.

37. The SW system of claim 33, wherein all of said at least one SW's in the network are cores of a single multicore processor.

38. The SW system of claim 37, wherein each core adds its own I/O to said multicore processor, and wherein said I/O is in the format of said network.

39. The SW system of claim 37, wherein said processor can have co-processors acting as at least one of said FW, said IPS and said IDS.

40. The SW system of claim 37, further comprising an Operating System (OS) that uses said at least one SW as said processor.

41. The SW system of claim 40, wherein said processor and said OS can run applications.

42. The SW system of claim 41, wherein at least one of said applications does the work of at least one of an FW, an IPS and an anti-virus.

43. The SW system of claim 41, wherein at least one of said applications is at least a virtual one of an FW, an IPS and an anti-virus.

44. The SW system of claim 41, wherein the SW system applications and OS can be distributed between cores.

45. The SW system of claim 37, wherein said at least one SW is grouped in clusters and wherein said network further comprises at least one of RAM and cache for sharing data between cluster items.

46. The SW system of claim 37, wherein said single multicore processor can be divided dynamically into smaller processors.

47. The SW system of claim 37, wherein all internal busses and external busses of said single multicore processor are in one network.

48. The SW system of claim 37, wherein said single multicore processor further comprises hierarchies of said multicore processors.

49. The SW system of claim 37, wherein said single multicore processor can have cores attached and removed dynamically.

50. The SW system of claim 37, wherein said single multicore processor can have a Plug and Play core.

51. The SW system of claim 1, further comprising a network mapping service.

52. The SW system of claim 51, wherein SW system can ping said at least one CS to verify that said at least one CS is in fact connected.

53. The SW system of claim 51, wherein the SW system can use lower level communication to perform Keep Alive, thereby bypassing software firewalls installed on the target machines.

54. The SW system of claim 53 wherein said lower level communication is MAC address based.

55. The SW system of claim 53, wherein said lower level communication is Address Resolution Protocol (ARP).

56. The SW system of claim 51, wherein the SW system can use the Physical Link indicator as part of said network mapping service.

57. The SW system of claim 51, wherein the SW system can make periodic attempts to connect to specific ports on said at least one CS; and a specific protocol, thereby helping to verify:
said at least one CS is in fact connected;
said at least one CS is correctly placed and connected to said designated I/O; and
said specific application on said at least one CS is up and running.

58. The SW system of claim 51, further comprising at least one system scanning model usually utilized by hackers for locating security faults, wherein said at least one system scanning model is visible as part of said single management and information system and is used for security decision making, thereby:
helping to verify that said at least one connected system is the correct one;
helping with Plug and Play connection of network devices so that a new machine connected to the network can be questioned in order to identify its nature and hosted applications and services; and
becoming a part of said network mapping service.

59. The SW system of claim 51, wherein the system can monitor network traffic:
as part of said Keep Alive mechanism;
as part of said Plug and Play system;
for detecting network vulnerabilities and infected systems; and
as part of said Network Mapping service.

60. The SW system of claim 51, wherein the system can enforce Network Policy that will make said at least one CS install at least one of the following items: updates, patches, and security aiding tools, such that the system forces said at least one CS to conform to said Network Mapping service before taking security actions.

61. The SW system of claim 51, further comprising a Clearance Ring management system, wherein said installed items can be utilized by said Clearance Ring management system that can automatically reduce clearance of a given system.

62. The SW system of claim 61, wherein Clearance Levels of said Clearance Ring management system are:
zero: meaning at least one of unknown and unverified;
positive: higher means more secure and in a more internal ring; and
negative: lower means more dangerous/isolated and in a more external ring.

63. The SW system of claim 1, wherein the following Services are provided by the system:
a Network Mapping service: a Management tool that helps define each said at least one CS and every application on said at least one CS, by one of manual definition and automatic detection;
a Keep Alive service: A background service that monitors the presence of said at least one CS, which can be used by said network management and information systems, said Network Mapping service, and said below-referenced Plug and Play service;
a Plug and Play service: Implementation of Plug and Play methodologies on a Network Function (NF), wherein said Plug and Play service has a management interface and can be used as a notification system;
a Clearance Rings Mapper: Provides means of defining Clearance Levels of a NF in one of manual and automatic mode;
a Policy and Procedures manager: Defines the Methods of Operation, the rules, the Procedures and the behavior of the system for given conditions, wherein these comprise the need to Clear a Data Frame from one Clearance Level to another, and rules and procedures for handling unordinary situations;
a Profiling System: keeps a profile of at least: each of said at least one CS on the network; every available APP on said at least one CS; the internal parts of the network system itself; the users and external systems; and said applications;
a Protocol Mapper: negotiates between two of said at least one CS's to find the most appropriate mutual protocol, said negotiation comprising at least an attempt to load a Protocol Converter, if required, that will work in the background;
a Bouncer service: In charge of handling attackers, attacking systems, infected systems, and other security vulnerabilities on the personal machine level, said bouncer service comprising at least demanding updates as part of the security policy, quarantine, penetration tests, system scanning and system/application repairs; and
a Sentinel service: In charge of securing the network from systems in the responsibility of said Bouncer service, said Sentinel service comprising at least rerouting a Cleared at least one NF through at least one of said FW and a security inspector before passing on the data to said Cleared network, even though both said at least one NF and the network may have the same Clearance Level, wherein said Sentinel service can be responsible for sending a suspicious one of said at least one NF to said Bouncer service, for quarantine, and wherein said Sentinel service can also decrement security via said Clearance Level and ‘detach’ at least one of said at least one NF from the network and a specific one of said applications on said at least one NF from the network, and wherein said at least one said Sentinel Service can tunnel said at least one NF directly to the external network and create a Virtual Network that is private for the given one of said at least one NF's.

64. The SW system of claim 1, wherein security is improved at least by compressing the data before encryption, thereby reducing repetitive data and thereby increasing the strength of the encryption.

65. The SW system of claim 1, wherein said network risk management device network element (SW) and system for a communication infrastructure is acting in place of at least one server.

66. The SW system of claim 1, wherein the network open system interconnection (OSI) 7 layer model is implemented by the network's communication infrastructure so that at least two of said at least one SW's implement OSI model layers internally between them regardless of communication between at least two of said at least one CS on the network.

67. The SW system of claim 1 wherein at least two of said at least one SW's are connected via an intermediate network so that said intermediate network is regarded as a virtual cable.

68. The SW system of claim 51, wherein said mapping service maps users of the network.

69. The SW system of claim 68, wherein said mapping service further comprises actively investigating network users by interacting with said users.

70. The SW system of claim 69, wherein said investigating said network users comprises simulating attacks and exploits, such that said user's responses help determine the type of said user.

71. The SW system of claim 70, wherein said investigating comprises at least one of sending a fake email asking for said user's password and asking to install a malicious attachment, thereby helping to determine said user's vulnerability to attacks that require action by said user.

72. The SW system of claim 8, wherein said MI is a mobile device comprising at least one of a cellular and a PDA device, and wherein said mobile device is notified using one of an SMS and MMS message, and wherein said MI manages the network and network topology using said mobile device, and wherein said SMS/MMS message contains information that will automatically direct said MI to an appropriate management display.

73. The SW system of claim 1, further comprising:
an operational mode: for active risk management;
a simulation mode: where the network actively reacts to artificially injected events in order to verify security and behavior;
an investigation mode: for initial mapping of the network and defining expected behaviors and checklists; and
an interrogation mode: for detection of faults found in said operational mode and said simulation mode, comprising at least going over logs and running simulations based on recorded data, wherein reference is made to the above-referenced co-pending provisional application: Software for a Realtime Infrastructure.
